(19) United States
(12) Patent Application Publication
(10) Pub. No.: US 2020/0254541 A1
(43) Pub. Date: Aug. 13, 2020

(54) TOOL HEAD UNIT FOR MACHINING WORKPIECES WITH THREE SIMULTANEOUSLY OPERABLE ROTARY AXES AND MACHINE TOOL USING SAME

(71) Applicant: F. ZIMMERMANN GMBH, Neuhausen (DE)

(72) Inventor: MOHAMED WASSIM BOURAOUI, OSTFILDERN (DE)

(73) Assignee: F. ZIMMERMANN GMBH, NEUHAUSEN (DE)

(21) Appl. No.: 16/525,748

(22) Filed: Jul. 30, 2019

(30) Foreign Application Priority Data
Feb. 7, 2019 (DE) 10 2019 103 009.9

(51) Int. Cl. B23C 9/00; B23C 1/12; B23Q 1/54

(52) U.S. Cl. CPC B23C 9/005; B23C 1/12; B23Q 2220/006; B23Q 2210/004; B23Q 1/5406

(57) ABSTRACT

A three-axis tool head unit for a machine tool spindle, which comprises three components, which are rotatable or pivotable relative to each other about independent axes. A first head part is rotatably mounted on a support arm about a first axis with respect to the support arm. A second head part is rotatably mounted on the first head part about a second axis with respect to the first head part. A spindle device is rotatably mounted on the second head part about a third axis with respect to the second head part. The third rotary axis is oriented orthogonally to the first and the second rotary axes, while the first and the second rotary axes are inclined relative to each other. Each of the three rotary axes has an associated individual drive device for driving and controlling the rotation of the component about its respective axis.

### CROSS-REFERENCE TO RELATED APPLICATION

This application claims the priority benefits of German Application No. 10 2019 103 009.9 filed Feb. 7, 2019. The said German Application No. 10 2019 103 009.9 is incorporated herein by reference as though fully set forth.

### BACKGROUND OF THE INVENTION

The present invention relates to a tool head unit for machining workpieces, such as a milling head unit for a milling machine, having three simultaneously operable rotary axes and a machine tool, in particular a milling machine, using such a tool head unit.

DE 10 2005 043 835 A1 describes a portal milling machine comprising a portal which is supported on side stands and is supported over a machine table firmly anchored to the foundation. A cantilever is held in a vertical arrangement on the portal which is movable in a horizontal X-direction, wherein the cantilever is movable via a cross-slide in a horizontal Y-direction perpendicular to the X-direction. The cantilever comprises a supporting beam which is movable in a vertical Z-direction and which carries a milling head with a motorized milling spindle.

The milling head as such comprises a fork which is rotatable by means of a torque motor around a C-axis which coincides with the Z-axis. The spindle housing of a milling spindle is pivotally received on two fork arms about an A-axis perpendicular to the C-axis. A further torque motor serves as a drive for pivoting the spindle housing about the A-axis. The milling spindle has a motor-driven milling tool that projects outwardly from the spindle housing to perform a machining operation on a workpiece positioned on the machine table during operation.

The milling machine is intended for making tools, molds and models or for the production in the automotive and aerospace industry and is capable of producing very large and complicated 3D parts which may have extremely fine surface details. Complex 5-axis simultaneous machining operations with high precision in a relatively short time are possible.

However, this two-axis milling head has the disadvantage that at the zero position A=0°, when the spindle axis and the C-axis coincide, a so-called pole arises. The C-axis pivots the milling spindle about its own axis only so that there is no change in the angle of the spindle with respect to the workpiece. Consequently, even for very small angular changes of the spindle, rotational movements of the C-axis of up to 90 degrees are necessary.

DE 20 2011 050 911 U1 discloses a two-axis milling head unit comprising two mutually inclined rotary axes C and B. The milling head unit comprises an angular milling head with two crank portions, which is pivotally connected at one end about the longitudinal axis C of a milling beam with integrated rotary drive to the milling beam. At another end, the angular milling head carries a spindle support which is pivotally arranged about the milling head axis B, which is inclined to the milling beam axis C, by means of a drive disposed on the outside of the angular milling head.

By inclining the milling head axis B relative to the milling beam axis C, the pole issue may be removed. However, with all two-axis milling head units that use a combination of the rotary axes C and A or C and B, further disadvantages are associated. For example, during the positioning of the milling tool into the angular position necessary for machining a workpiece, it may be necessary to rotate the milling tool back via a considerable angle if there is an unfavorable angular position about the A-axis and when reaching an axis limit of the C-axis. For example, due to the required cable and hose routing for cooling, lubrication, power supply and signal transmission, the rotation about the C-axis may be limited to about +/−180° with respect to a predetermined zero position. In extreme cases, for only a small change in position, a re-adjusting about the C-axis by almost one complete revolution must be made. As a result, the processing speed can be significantly reduced.

In addition, when using a two-axis milling head, an electronic orientation error compensation is hardly possible. For example, due to manufacturing tolerances, wear, aging, as a result of the dynamic operation and the like, dimensional and geometrical errors, such as, for example, non-straight axes, bending of components, portal sagging, etc., may arise. These might be compensated by measuring the measuring space and suitable calibration and compensation measures by means of the driving axes. However, this may not be possible for all measuring space positions and errors are possible if only two rotary axes C, A and C, B, respectively, are available. Therefore, all components of a two-axis milling head and the entire milling machine must be manufactured and work with very high precision to obtain the required quality.

WO 00/25976 A2 discloses an articulated tool head based on the principle of rod kinematics, which comprises a tool platform movable in three axes. At least three control mechanisms, which can be displaced independently and parallel to each other, are coupled to the tool platform, and at least three parallel linear motion drive units for the control mechanisms are arranged at a distance around the tool platform. Due to the mounting of the tool platform, a motor spindle mounted thereon can be quickly brought into any required position within the measuring space. However, the measuring space is relatively small due to a considerably limited length of the linear axis and pivoting angles limited to about +/−40°. This limits the scope of application. Large 3D parts, as they are customary in model mold and molding tool making, for example, are hardly manufacturable.

DE 198 50 603 A1 discloses a milling head unit with a cardanic mounting of a milling spindle. The milling head unit has a bearing housing which is fixed to a spindle beam movable in X-, Y- and Z-directions and a pivot housing which is pivotally received in the bearing housing about a first axis B. The pivoting movement about the B-axis is effected by torque motors which are flange-mounted on both sides to the bearing housing and directly drive the pivot housing. A spindle receiving housing is pivotally mounted abut a horizontal A-axis in the pivot housing and is pivoted by means of torque motors arranged on both sides. The spindle receiving housing carries a motorized milling spindle with a direct drive for a milling tool. Due to the two mutually orthogonal pivot axes A, B of the milling head unit, which are not parallel to the Z-axis, the milling spindle can be pivoted quickly directly into the respectively required processing position. A pivoting about a C-axis that coincides with the Z-axis is not required. An electronic orientation error compensation is also possible.

However, the cardanic mounting, as it is proposed in DE 198 50 603 A1, is of a relatively large construction. Each housing is formed substantially box-like to receive therein another housing together with a drive shaft therefor. As a result, the pivoting angles about the pivoting axes A, B are also considerably limited.

EP 1 892 055 B1 further discloses a 3-axis milling head having three mutually orthogonal rotary axes which can be simultaneously driven in rotation. The milling head comprises a support which has a first rotary axis C with associated drive means, a pivoting body mounted on the support, which can be pivoted about a second rotary axis B relative to the support by means of a second drive means, and a machine tool spindle mounted on the pivoting body, which can be pivoted about a third rotary axis A relative to the pivoting body by means of a third drive means and which carries a milling tool. The pivoting body comprises a C-shaped main body with an arcuate peripheral surface, axial end faces and a recess between the C-legs of the pivoting body, in which the machine tool spindle is received. The pivoting body itself is pivotally mounted and guided about the B-axis relative to the support only by a curved guide means active therebetween, which is arranged along the periphery of the main body.

The milling head has proven itself in practice. The three mutually orthogonal, simultaneously drivable rotary axes A, B, C allow to manage even challenging tasks of a three-axis milling head, like hobbing pockets having surrounding inclined walls, for example, with high dynamics, quickly, without interruption, in particular without re-adjusting the C-axis, and with high accuracy. In addition, dimensional and geometrical errors of the machine can be well-compensated.

However, the structure of the milling head is relatively complicated and expensive, which is in particular due to the use of the special curved guide means. Accessibility to the internal components of the milling head is limited. In addition, a disadvantage of the milling head is the limited pivoting range of the B-axis, which in practice is about +/−15°. It would be desirable to have a larger pivoting range for the B-axis in order to be able to produce more complex surface features on workpieces quickly and accurately.

On this basis, an object of present invention is to remove the above disadvantages or deficiencies. In particular, it is an object of present invention to provide a dynamic tool head unit which is suitable for tool, mold and model making, has a relatively compact design and provides for relatively large pivoting angles. Preferably, the structure of the tool head unit should enable an electronic orientation error compensation.

Another object of present invention is to provide a machine tool having such a tool head unit, with which even large and complex 3D parts can be manufactured at a high processing speed.

### SUMMARY OF THE INVENTION

These and other objects of present invention are solved by the tool head unit and the machine tool according to the invention having the features of the claims. A three-axis tool head unit 1 for a machine tool spindle 11, in particular a three-axis milling head unit, is disclosed, which comprises three components 16, 17, 18, which are rotatable or pivotable relative to each other about independent axes A, B, C. A first head part 16 is rotatably mounted on a support arm 14 about a first axis C with respect to the support arm 14. A second head part 17 is rotatably mounted on the first head part 16 about a second axis B with respect to the first head part 16. A spindle device 18 is rotatably mounted on the second head part 17 about a third axis A with respect to the second head part 17. The third rotary axis A is oriented orthogonally to the first and the second rotary axes C, B, while the first and the second rotary axes C, B are inclined at an angle between 30° and 60° relative to each other. Each of the three rotary axes C, B, A has an individual drive device 19, 21, 22 associated therewith for driving and for controlling the rotation of the component 16, 17, 18 about its respective axis C, B, A. The three-axis tool head unit 1 offers large pivoting ranges of the axes with small interfering contour and allows fast and precise positioning of a machine tool spindle 11 into the required machining position. A machine tool 1, in particular a milling machine, with such a three-axis tool head unit 1 is also disclosed.

The tool head unit intended for machining workpieces according to the invention comprises a support arm which defines a first axis C, a first head part which is mounted on the support arm, is rotatably arranged about the first axis C relative to the support arm and defines a second axis B inclined with respect to the first axis C, a second head part which is mounted on the first head part, is rotatably arranged about the second axis B with respect to the first head part, and a spindle device which is mounted on the second head part, is rotatably arranged about a third axis A with respect to the second head part. Drive means are associated with the first, second and third axes C, B, and A, which drive means serve to separately drive and control the rotations of the first head part, the second head part and the spindle means about the respective first, second and third axis C, B, and A.

According to the invention, for quick and accurate positioning of the spindle device with the working tool mounted thereon into the respectively required angular position during machining operations, three independently and simultaneously drivable rotary axis are provided, each of which is assigned its own controllable drive device. Thus, the components of the three-axis tool head unit can be quickly and precisely rotated or pivoted with respect to each other to set any desired machining position. By providing three independent rotary axis, pole positions as in the classic AC rotary head can be bypassed, and short machining times can be ensured by avoiding unnecessary re-adjustment when an axis limit, in particular of the C-axis, is reached.

In addition, the three controllable rotary axis offer the possibility of calibration and compensation of dimensional and geometric errors of the machine. For this purpose, the measuring space can be measured accurately with different positionings of the tool head unit, and the detected deviations between the actual and set point values of the positionings can be used by a control unit to automatically adjust the tool head unit into the accurate position by means of the three rotary drive axes during machining. Thus, requirements for the production and assembly accuracy of the components, guides and bearings can be reduced while maintaining the quality of the products produced. Furthermore, costs are reduced.

According to the invention, the second rotary axis B is specifically inclined at an angle different from 0° and 90° with respect to the first rotary axis C. It is, thus, also referred to here as the inclined or oblique axis B. The inclination angle of the oblique axis B with respect to the first rotary axis C is generally in the range of 30° to 60°, in preferred embodiments in the range of 40° to 50°. Most preferably, the angle of inclination is about 45°. The inclined axis B provides the basis for a relatively large pivoting range of the B-axis. At a 45° angle of inclination between the B- and the C-axis, the interpolated spatial B-axis can be pivoted by up to +/−45°, for example. Also, the pivoting range of the A-axis can be sized relatively large and, depending on the design, be −90° to +120° or even more.

A simple construction with good accessibility to the components can be provided. Due to the inclined axis B, the components of the tool head unit no longer need to be formed with a box-like shape and nested in one another or provided with a special curved guide means. The components can be dimensioned much smaller, and the space requirement can be minimized. This results in a compact design of the tool head unit with low interfering contour and low moving masses. High accelerations of the driven axis are possible so that a highly dynamic tool head unit and machine tool can be realized. Optionally, existing X, Y and Z drives for moving the tool head unit in all three spatial directions can be made smaller.

In a preferred application, the tool head unit according to the invention is provided as a milling head unit for receiving a milling spindle. Preferably, it comprises a motorized milling spindle having its own motor drive for the tool of the milling spindle. It can be used for vertical milling machines, in particular portal milling machines, or for horizontal milling machines as well. Other applications of the tool head unit according to the invention, such as, for example, for drilling and for other machining operations, are also possible.

In preferred embodiments of the invention, the first rotary axis C and the third rotary axis A are orthogonally oriented relative to each other, and the second rotary axis B is orthogonally oriented relative to the third rotary axis A, but is inclined with respect to the first axis C. An “orthogonal B-axis” relative to the A- and C-axes (spatial B-axis) can be interpolated during operation simply by moving respective two or three of the axes A, B, and C. In principle, a relative inclination between the axes B and A is also possible.

In embodiments of the tool head unit, the first, second and third axis may intersect at a common point. This results in a simple arrangement in which the C-axis coincides with the spindle axis in the zero position of the A- and B-axes (A=0°, B=0°).

However, in other preferred embodiments, the first and third axes C, A may be offset relative to each other, while the second axis B intersects the first and the third axes C, A. Due to the axial offset or the eccentricity between the A- and C-axis, the construction can be optimized to obtain short lever arms, in particular on the first head part, which benefits the rigidity and dynamics. The interfering contour of the entire tool head unit can be optimized for the particular application.

In still other embodiments, the third axis A may be offset from both the first and second axes C, B, while the second axis B intersects only the first axis C. As a result, the entire length of the tool head unit can be reduced if necessary. Embodiments are also possible in which the C and B rotary axes are additionally offset relative to each other and do not intersect.

In all of the aforementioned embodiments, the first, second and spindle axes may preferably all run in a common plane (when all axes are in the zero positions) to avoid unnecessary levers and associated bending stresses. But an axial offset along the A-axis is possible if required.

In embodiments of any of the aforementioned tool head unit, the support arm may be substantially cylindrical, for example, and may include means, e.g. a mounting flange, for attachment to a support of a machine tool. The support arm includes the first drive device and may comprise a hollow cylindrical motor shaft driven thereby, which is arranged coaxially to the first rotary axis C. The motor shaft may be adapted for attachment of the first head part thereto.

The first drive device may advantageously comprise a first torque motor which is coupled thereto for directly rotatably driving the motor shaft. As used herein, the term “torque motor” refers to a servomotor whose geometry is specifically designed for high torque or forces rather than high power output. The construction of torque motors is, therefore, rather short and with a large diameter. To keep copper losses and electrical time constants small, these motors also have more poles than conventional servomotors. They also have a sufficiently large thermal time constant. As a result, an extremely high torque can be achieved even at very low speeds. In brief, with these motors, the output of torque or force is optimized rather than the efficiency. Modern versions are, from an electrical point of view, three-phase brushless synchronous motors with permanent excitation. Versions with external or internal rotor are known. Torque motors are offered separately by motor manufacturers in addition to conventional servomotors, wherein complete built-in units consisting of a rotor, stator, bearings and integrated cooling are also available.

The torque motors used in the invention for the rotary axes are preferably each in the form of a directly driven round motor having a stator formed as an outer ring with three-phase windings and a rotor formed as an inner ring with permanent magnets, which rotor is arranged inside the stator, concentrically therewith. However, torque motors with an external motor may also be used. The use of torque motors as direct drives for the C-axis allows a high torque output, high dynamics and stiffness, low susceptibility to wear and easy installation and repair compared to servomotors. But servomotors, even in combination with a transmission device, can also be used herein.

In preferred embodiments of any of the aforementioned tool head units, the first head part may include an angled housing cranked one or several times, the angled housing having a first end that is substantially cylindrical, in particular configured and arranged to fit to the motor shaft of the support arm to be mounted thereto in a coaxial arrangement with respect to the first rotary axis C. The cranked angled housing can have a second end which defines a cylindrical receiving aperture for the second head part, which is coaxial to the second axis B.

The second drive device can be accommodated in the interior of the angled housing and may comprise at least a second torque motor. With regard to the second torque motor, what has been said above regarding the first torque motor of the first drive device applies correspondingly. However, the second drive device preferably includes a reduction gear transmission device drivingly interposed between the second torque motor and the second head part for transmitting rotational movement of a rotor of the second torque motor about the second axis B to the second head part. By interposing the transmission device in the B-axis drive train the second torque motor can be designed significantly smaller than in direct drives while achieving a high torque. As a result, the structural volume and weight of the first head part can be minimized.

The reduction gear transmission device of the second drive device may preferably form a non-self-locking single-stage gear unit which is preferably mechanically or electronically clamped. Backlashes in the gear unit can be largely eliminated to ensure sufficient rigidity and dynamics. In advantageous embodiments, the second drive device may comprise two second torque motors, for example, which each rotationally drive a pinion shaft of the gear transmission device, wherein the pinion shaft may be in meshing engagement free of backlash with a common ring gear of the gear transmission device via a helical gearing, for example. A backlash may be eliminated, for example, by driving the motors to slightly work against each other. Alternatively, only a single torque motor can be used for the second drive device, wherein e.g. a beveloid gearing or the like can provide for a backlash-free mechanical clamping of the drivetrain.

It is also possible to provide clamping and adjusting devices for backlash-free mechanical clamping of the gear transmission and automatic compensation of backlashes. Such spring-loaded automatic clamping and adjusting devices are known from DE 10 2005 043 835 A1, for example, the corresponding disclosure of which is explicitly incorporated herein by reference.

In preferred embodiments of any aforementioned tool head unit, the second head part is formed as a substantially U-shaped fork having a base for attaching the fork to a driven portion of the second drive device of the first head part and legs projecting freely from the base. The legs are substantially parallel to and spaced from each other and form fork arms. The spindle device can be pivotally accommodated between the fork arms. This results in a structurally simple, clear arrangement.

The spindle device can, in particular, include a spindle receptacle which is pivotally arranged between the fork arms and is adapted to receive a machine tool spindle. A work spindle, e.g. a milling spindle, can be secured within the spindle receptacle, wherein different work spindles, e.g. for roughing or for finishing or also for drilling, can be provided. The work spindle is preferably rotatably driven by its own integrated rotor which is decoupled from the drive devices for the rotary axes. A gear spindle with an upstream spindle motor, e.g. in a Z slide over the C-axis or in another head section, e.g. in the angled housing or the like, might also be used, wherein the rotational movement of the spindle motor is transferred to the spindle shaft via gear stages, mostly spur or beveloid gear sets for parallel or inclined axes. Such gear spindles are well-known for the A- and B-axis drives of milling heads.

Each fork arm of the second head part may comprise a housing which defines or limits an interior. In preferred embodiments, the third drive device may be completely accommodated within the interior space of a single fork arm. In the other fork arm, other required equipment, such as hoses for supplying coolant or lubricant or the like, can be accommodated. The number of components can thereby be reduced (a single driven gear) and a simple structure is provided which allows good accessibility and easy maintenance and servicing. The third drive device may also be distributed to both fork arms to drive the spindle device from both sides.

In preferred embodiments, the third drive device has at least a third torque motor and preferably another reduction gear transmission which is drivingly interposed between the third torque motor and the spindle device for transmitting a rotational movement of a rotor of the third torque motor about the third rotary axis A to the spindle device. The further reduction gear transmission can form a non-self-locking, preferably one-stage gear unit and be preferably mechanically or electronically clamped. The at least one third torque motor and the further reduction gear transmission may be similar to the at least one second torque motor and the reduction gear transmission device so that the respective remarks apply herein correspondingly.

In particular embodiments, the third drive device comprises two third torque motors, each of which rotatably drives its own further pinion shaft associated with the further gear transmission device. The further pinion shafts are in meshing engagement free from backlash with a common spur gear of the further gear transmission device, e.g. via a helical toothing, wherein the spur gear is rotatably connected to the spindle housing of the spindle device. A backlash can be eliminated e.g. by driving the motors such that they slightly work against each other. Alternatively, only one torque motor can be used for the third drive device, wherein e.g. a beveloid toothing or the like can provide for a backlash-free clamping of the drive train.

An electronically clamped drive can also be provided e.g. by a motor controller causing the two torque motors to slightly work against each other. As a result, a permanently backlash-free and maintenance-free drive without special toothing of the gear train can be provided in a simple manner.

In alternative embodiments of any above-mentioned tool head unit, the second drive device or the third drive device or both can comprise a second and third torque motor, respectively, which is arranged for direct rotary drive of the second head part or the spindle device. By providing direct drives for the B and/or A-axis, the rigidity of the drive assembly can be increased and the dynamics of the tool head unit can be improved although the space is increased slightly with comparable performance.

In general, different types of drives can be used for all rotary axes A, B, C, in principle, depending on the application and requirements, wherein substantially backlash-free drives should preferably be used. These include, for example: torque motor direct drives which may be provided individually or in tandem; clamped drives having two or more motors and motor-gear combinations, wherein the gear unit may preferably be designed in one stage, but also in more stages; clamped drives having a single motor and a mechanically clamped gear unit, e.g. with clamped or beveloid gears; worm gears; or electronically clamped drives. Depending on the application, the use of drives with backlashes cannot be ruled out, in principle.

In preferred embodiments of any above-mentioned tool head unit, each rotary axis A, B, C, may be associated with an individual measuring system for measuring the relative angular position and/or angular velocity of a rotor with respect to a stator of the respective drive device for the respective rotary axis. Different types of measuring systems can be used, wherein orientation and position measuring systems are generally used. The speed, acceleration and jerk values can be determined from the position measurement values by time derivation. For this purpose, different, preferably contactless or non-contact measuring systems, which operate optically, magnetically or capacitively, for example, or also tactile measuring systems are known from the art. The measurement signals acquired by the high resolution measurement systems may be communicated to a tool head unit controller and used to precisely position the work tool with respect to the workpiece, including a compensation for dimensional and geometrical errors of the machine.

In accordance with a further aspect of present invention, a machine tool, in particular a milling machine constructed with a vertical portal or horizontal type design, for example, is provided, the machine tool comprising a support which is positionable in a three-dimensional measuring space, e.g. in X, Y, and Z coordinate directions, wherein the support comprises a tool head unit, in particular milling head unit, having the aforementioned features. A machine tool suitable for very large 3D parts and 6-axis simultaneous machining with a highly flexible, dynamic tool head can be provided, which can be used to produce complex and extremely fine surface details with high precision and machining speed.

### BRIEF DESCRIPTION OF THE DRAWINGS

Other advantageous details of the invention become apparent from the claims, the drawings and the accompanying description. In the drawing, an embodiment of the subject-matter of the invention is shown. Therein:

FIG. 1 shows an exemplary portal milling machine according to the invention in a schematic perspective view;

FIG. 2 shows an enlarged illustration of a milling head according to the invention, which can be used in the portal milling machine according to FIG. 1, according to an embodiment, in a simplified perspective view;

FIGS. 3a and 3b show the milling head according to FIG. 2 in simplified perspective illustrations, viewed from different viewing directions, with the housing partially open;

FIGS. 4a-4c show different planar side views of the milling head of FIG. 2, in simplified illustrations and with the housing partially open;

FIGS. 5-7 show various longitudinal sectional views of the milling head of FIG. 2, in simplified illustrations;

FIGS. 8a-8c show different constructive variants of a tool head according to the invention, e.g. the milling head according to FIG. 2, in greatly simplified schematic illustrations; and

FIGS. 9a and 9b show further embodiments of a tool head which can be used in machine tools, according to the invention, in simplified illustrations, partially cut away.

### DETAILED DESCRIPTION OF THE INVENTION

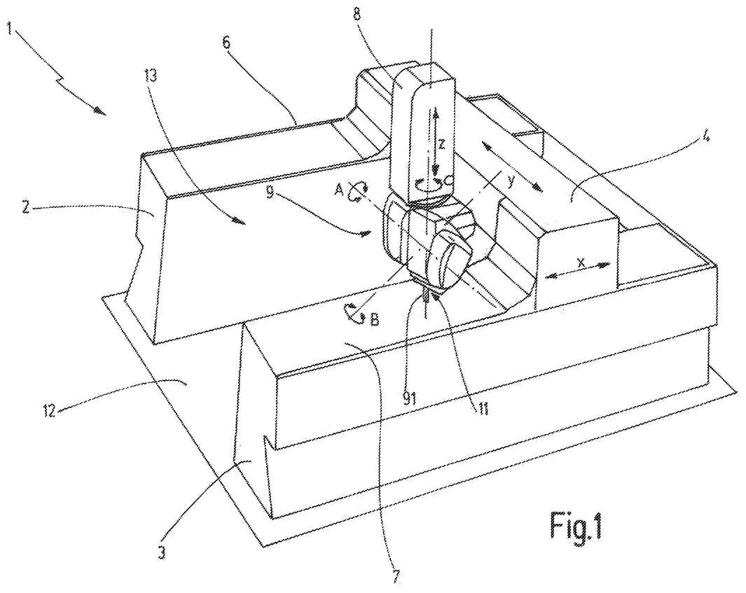

FIG. 1 schematically illustrates a portal milling machine 1 according to the present invention. The portal milling machine 1 has a portal 4 which is supported on elongated solid side stands 2, 3 and which can be moved in a horizontal X-direction indicated by a double arrow and is precisely guided via guides 6, 7 which are only indicated herein and are provided on the two side stands 2, 3. A support beam 8 is held on the portal 4 in vertical arrangement and can be moved via a cross-slide along the portal 4 in the indicated horizontal Y-direction and via a Z-slide in the vertical Z-direction. The support beam 8 carries a milling head unit 9 with a milling spindle 11 which is used for machining a workpiece, not shown herein in detail, which is to be arranged on a machine table 12 firmly anchored to the foundation. The milling head 9 with the milling spindle 11 can thus be positioned anywhere in all three coordinate directions X, Y, and Z of a three-dimensional measuring space 13 defined by the side stands 2. The drive devices for the linear axes, e.g. linear motors, associated guides, slides, position measuring systems and controllers, are not explicitly depicted in FIG. 1 for convenience. They are known per se and not subject-matter of the invention.

It should be noted that the portal milling machine 1 and the milling head unit 9 represent only examples of a machine tool and an application in which the milling head unit 9 according to the invention may be used. It may be used for both vertical and horizontal machine tools. It may be used for different applications, e.g. also for drilling and for other machining operations. In this respect, if a milling head unit 9, or shortened a milling head 9, is referred to in the following, it is generally understood to mean a tool head unit for a work spindle 11 for machining workpieces.

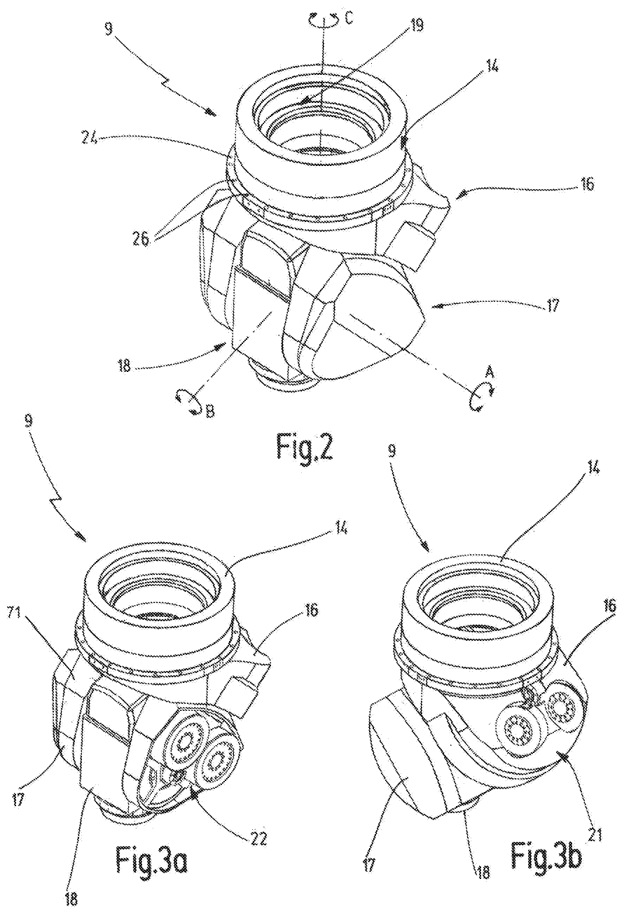

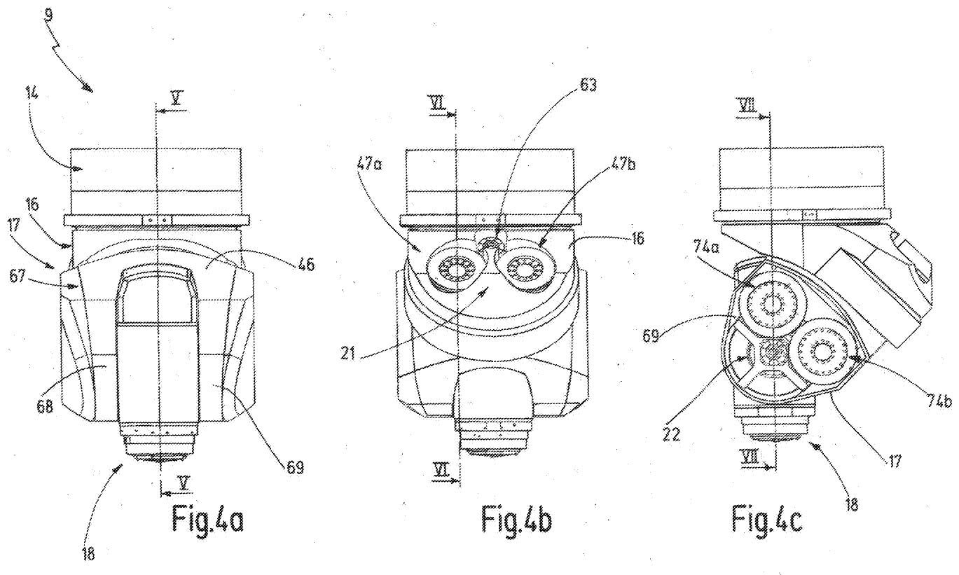

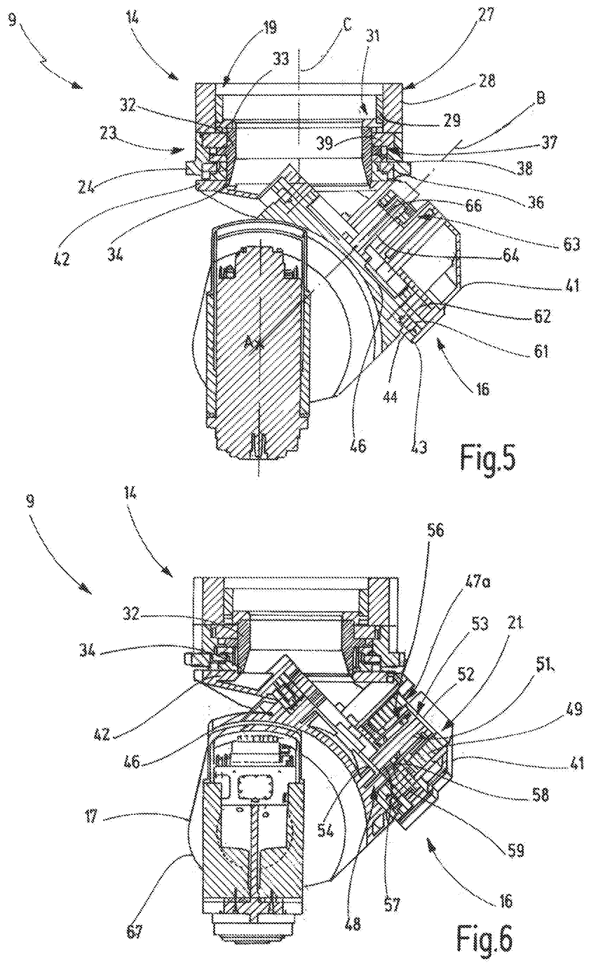

A first embodiment of a milling head 9 according to the invention is illustrated in greater detail, somewhat schematically and partly at different scales, in FIGS. 2 to 4. The milling head 9 essentially includes a support arm 14 which serves for attachment to the support beam 8 and which defines a first rotary axis C, a first head part 16 mounted on the support arm 14, the head part 16 being rotatably arranged about the first rotary axis C with respect to the support arm and defining a second axis B inclined with respect to the first axis C, a second head part 17 which is mounted on the first head part 16 and is rotatably arranged about the second rotary axis B with respect to the first head part 16, and a spindle device 18 mounted on the second head part 17 and rotatably arranged about a third rotary axis A with respect to the second head part. Each of the rotary axes C, B, and A is associated with an individual drive device 19, 21, and 22, respectively, for separately driving and controlling the rotation of the first head part 16, the second head part 17 or the spindle device 18 about the respective first, second, or third rotary axis C, B, or A. The first drive device 19 for the C-axis can be seen in the FIGS. 2, 3a, and 3b, while the second and the third drive devices 21, 22 can be taken in particular from the FIGS. 3a, 3b, 4b, and 4c, in which housing covers of the housing of the milling head 9 are partly removed to permit a look at the drive devices 21, 22.

As can also be seen from FIG. 1, when the milling head 9 is used on the vertical portal milling machine 1, the first rotary axis C coincides with the vertical direction Z, while the second rotary axis B of the milling head 9 is inclined with respect to the rotary axis C and the horizontal XY plane, and the third rotary axis A is a horizontal axis which extends in the XY plane. It should be noted that, in accordance with the common convention in the art, in the zero position of the rotary axes, the C-axis defines the rotation about the Z-axis which is perpendicular to the machined workpiece surface, while the A-axis, which is orthogonal to the C-axis, defines the rotation about the X-axis, which extends in the direction of the longest travel of the machine, and the B-axis (referred to herein as the spatial B-axis), which is orthogonal to the C- and A-axes, defines the rotation about the Y-axis. In the illustrated example, and in accordance with an aspect of the invention, the second rotary axis B of the milling head 9 (also referred to as the B head axis) purposefully does not coincide with the spatial B-axis, but is obliquely oriented with respect thereto and to the rotary axis C at an angle which differs from 0° and 90°. In addition, in the illustrated example, the third axis A is horizontally offset from the first axis C, and the B-axis intersects both the C-axis and the A-axis.

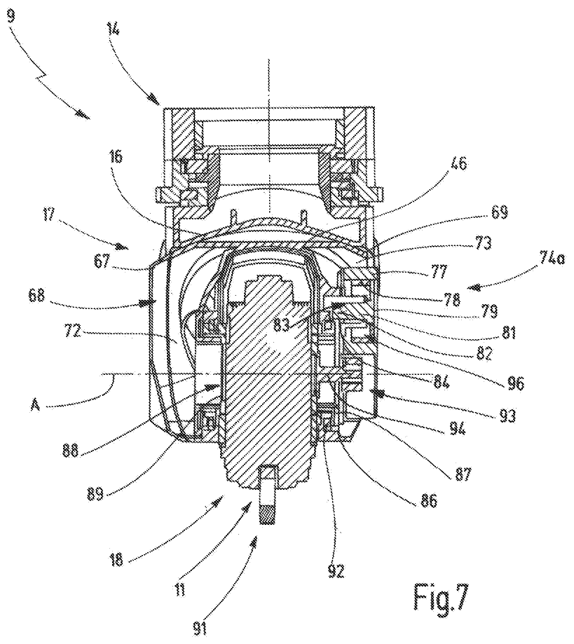

The above-mentioned components 14-22 of the milling head 9 according to FIGS. 1-4 are illustrated in greater detail in FIGS. 5-7 which show longitudinal sectional views through the milling head 9. FIG. 5 shows a sectional view along the section line V-V in FIG. 4a, while FIGS. 6 and 7 show sectional views along the section line VI-VI in FIG. 4b and the section line VII-VII in FIG. 4c, respectively.

The support arm 14 has a substantially cylindrical shape with a cylindrical or tubular support body 23, from which a radial flange 24 projects outwardly, which serves for attachment of the support arm 14 or the milling head 9 onto the support of the machine tool, e.g. the support beam 8 of the portal milling machine 1. As is apparent in particular from FIGS. 2 and 3, the mounting flange 24 may have bores 26 for screw fastening of the radial flange 24 on the support of the machine tool, but other types of fastening for the support arm 14 are also possible.

The first drive device 19 is attached to the mounting flange 24. The first drive device 19 is arranged here for direct drive and control of the rotation of the first head part about the C-axis. It is formed by a first torque motor 27, such as a servomotor designed for high torques, which basically comprises an annular stator 28 and a rotor 29 which is rotatably arranged inside the stator 28. The stator 28 is fixed to the support body 23, while the likewise annular rotor 29 is arranged radially opposite the stator 28 forming a small gap and is rotatably connected to a motor shaft 32 via connecting means 31.

The motor shaft 32 is formed substantially hollow cylindrically with a first end 33 connected to the stator 28 of the torque motor and an opposite second end 34, the lower end in FIGS. 5-7, which is used to attach the first head part 16 to the support arm 14. An axial-radial bearing 36 interposed between the second end 34 of the motor shaft 32 and the support body 23 provides radial and axial support and rotatable mounting of the assembly of the stator 28 and the motor shaft 32 with respect to the support body 23.

A first measuring system 37 is provided for measuring the relative angular position and/or angular velocity of the motor shaft 32 and the rotor 29, respectively, with respect to the fixed support body 23 and the stator 28, respectively. For this purpose, the motor shaft 32 includes, in the illustrated example, in its central portion, an annular collar 38, which projects outwardly and is provided with a material measure thereon, the passing of which can be detected by a sensor or measuring transducer, which may be fixedly attached to the support body 23. The material measure and the sensor are not specifically shown in the figures. It is possible to use different, preferably contactless or non-contact measuring sensors or measuring systems, which operate in an optical, magnetic or capacitive manner, for example, and which are able to transmit measuring signals indicating the sensed angular positions or velocities to a controller of the milling head, not shown here in detail, which controls the positioning of the work spindle 11.

In addition, a first clamping device 39 may be interposed between the motor shaft 32 and the support body 23, the first clamping device 39 being arranged for locking the motor shaft 32 in the desired angular position during the machining of a workpiece to prevent an unintentional rotation of the motor shaft 32 about the C-axis due to reaction forces during the machining of the workpiece.

As can be seen from the figures, the first head part 16 comprises an angled housing 41 which is cranked several times in order to accommodate the mutually inclined axes C and B. As is in particular apparent from the FIGS. 5 and 6, the angled housing 41 has a first end or a first section 42, which is formed substantially cylindrically, in particular matching the motor shaft 32 of the support arm 14, so as to encompass the second end 34 of the motor shaft 32 and to be mounted thereon. Appropriate attachment means, e.g. screwing means for securing the first end 42 of the angled housing 41 to the second end 34 of the motor shaft 32, are omitted in the figures for clarity. In any case, when the angled housing 41 is fixed to the motor shaft 32 in such a manner, the first head part 16 is rotatable or pivotable together with the motor shaft 32 about the C-axis.

The angled housing 41 further comprises a second end or a second section 43, which defines a receiving opening 44 for the second head part 17, which is cylindrical and coaxial with the second axis B. The receiving opening 44 is sized and arranged to receive a base 46 of the second head part 17 and to secure it such that the second head part 17 can be rotated about the B-axis which is inclined to the C-axis.

The second drive device 21 is used for driving and controlling the rotation of the second head part 17 about the second axis B. As is apparent in particular from FIGS. 3b, 4b and 6, the second drive device 21 is formed herein by a gear drive which includes two second torque motors 47a, 47b and a reduction gear device. The second torque motors 47a, 47b are formed in a manner similar to the first torque motor 27 of the first drive device 19 as round motors with an outer stator ring 49 carrying three-phase windings and an inner rotor ring 51 provided with permanent magnets. However, since they are not designed as direct drive motors, the torque motors 47a, 47b are sized significantly smaller than the first torque motor 27, because their torque output is amplified and transmitted to the second head part 17 by the reduction gear device 48. Consequently, only a small space is required for accommodating the second torque motors 47a, 47b within the angled housing 41 of the first head part 16.

As can be seen in particular from FIG. 6, the stator ring 49 of the torque motor 47a is rigidly fastened to the angled housing 41, while the rotor ring 51 is rotatably arranged within the stator ring 49 and at a short radial distance therefrom. The rotor ring 51 is rotatably connected, e.g. screwed, at the outer end to a first shaft end 52 of a pinion shaft 53. The pinion shaft 53 extends from the first shaft end 52 through the interior of the rotor ring 51 and protrudes with its second shaft end 54 beyond the rotor ring 51 and the stator ring 49. In its intermediate portion, the pinion shaft 53 together with the rotor ring 51 is axially and radially supported and rotatably mounted on the angled housing 41 via a suitable bearing means 56, such as two tapered roller bearings which are spaced from each other.

It should be understood that each of the second torque motors 47a, 47b is of the same construction with the stator ring 49 and the rotor ring 51 and the pinion shaft 53 disposed therein. The two pinion shafts 53, which are associated with the two second torque motors 47a, 47b are part of the reduction gear device 48 which is drivingly interposed between the second torque motors 47a, 47b and the second head part 17. The two pinion shafts 53 include at their second shaft ends 54 an external toothing 57 which is in meshed engagement with a matching internal toothing 58 of a ring gear 59. The ring gear 59 is rotatably connected, preferably screwed, to the base 46 of the second head part 17. Thus, the base 46 of the second head part 17 rotates together with the ring gear 59 about the second rotary axis B when the ring gear 59 is driven in rotation by the second torque motors 47a, 47b via the reduction gear device 48.

The exemplary embodiment of the second drive device 21 illustrated herein offers many advantages. Advantageously, very high torques can be generated by a suitable reduction which is to be selected at least 1:2, preferably at least 1:4 or even larger, for which purpose very slim, compact and lightweight torque motors 47a, 47b suffice. Thus, a first head part 16 and a milling head 9 as a whole can be provided with a small volume and low interfering contour, which is also well suited for machining operations in a limited space. The mass of the assembly can be kept low. Moreover, since the mass acts far away from the bearings of the machine tool 1, the tendency to form oscillations or swinging movements during operation is reduced. This provides the basis for a high rigidity and dynamics of the machine and for a high surface quality even at high feed rates and fast load changes. Despite of the reduction ratio introduced, the rotational speed around the B-axis is sufficient. In this respect, preferably only one reduction stage is provided. A multi-stage transmission would also be possible in principle.

It is also an advantage to have a gear transmission device 48 which forms a non-self-locking transmission. Damages, when the milling head 9 runs against an obstacle, can thus be largely avoided or at least reduced. In addition, only a single gear stage is preferably provided in order to effectively prevent a compliance of the transmission or the power transmission line.

It is also advantageous if the gear device 48 is mechanically clamped free from backlash such that there are hardly any backlashes between the toothings which mesh with each other. The backlash-free clamping can be achieved by using gear units with clamped or beveloid gears, worm gears or the like. A clamping can also be done electronically by the two torque motors 47a, 47b being driven by the controller such that they slightly work against each other.

Referring again to FIGS. 5 and 6, it is apparent that the ring gear 59 is axially and radially supported and is rotatably mounted together with the base 46 of the second head part 17 mounted thereon with respect to the second end 43 of the angled housing 41 via an axial-radial bearing unit 61.

In addition, an axis clamping unit 62 for the B-axis, as shown schematically in FIG. 5, is interposed at the second end 43 of the angled housing 41 between the latter and the ring gear 59 to lock or fix the ring gear 59 with the second head part 17 rotatably connected thereto in a desired angular position with respect to the second axis B during operation. The clamping does not need necessarily to act directly on the ring gear 59, but may also act on a separate ring.

A second measuring system 63 is provided for determining the angular position and/or angular velocity of the second head part 17 about the second rotary axis B. In the illustrated example, as shown in FIG. 5, a shaft extension 64 is secured to the base 46 of the second head part 17 and extends outwardly from the base 17 coaxially with the B-axis. At its free end 66, the shaft extension 64 may carry a material measure which can be detected by an opposing sensor or measuring transducer rigidly attached to the angled housing 41. The material measure and the sensor are not shown in detail in the figures for clarity. However, the same remarks as given for the first measuring system 37 also apply in principle to the second measurement system 63. As for the rotary axis C, hollow ring measurement systems or the like can also be used for the B-axis.

Referring now in particular to FIGS. 3a, 4a, 4c, and 7, the second head part 17 is explained in more detail below. As can be seen, the second head part 17 is formed by a substantially U-shaped fork 67 which comprises the base 46 for attaching the second head part 17 to the ring gear 59. The fork 67 further comprises here two legs 68, 69 which protrude from the base 46 and run substantially parallel to and spaced from each other forming fork arms of the fork 67. The fork 67 includes a housing 71 which defines interior spaces 72, 73 in the region of the fork arms 68, 69 for accommodating components of the second head part 17.

In FIGS. 3a and 4c, a wall of the fork housing 71 is removed in order to permit a look into the interior space 73 of the fork arm 69. As can be seen, in the illustrated example, the third drive device 22 for the third rotary axis A is also formed (like the second drive device 21) by a combination of two third torque motors 74a, 74b and a further reduction gear transmission 76 which is drivingly interposed between the third torque motors 74a, 74b and the spindle device 18 to transfer the rotation of the third torque motors 74a, 74b into a rotating movement of the spindle device 18 about the A-axis.

The third torque motors 74a, 74b are arranged at a short distance from each other in the circumferential direction about a center of the fork arm 69 and are formed in a manner similar to the second torque motors 47a, 47b. They have an outer annular stator 77 which is suitably fixed to the fork housing 71 in the interior space 73 and an inner annular rotor 78 which is arranged opposite to the stator 77 with a small radial gap therebetween and is rotatably mounted.

At an outer end in FIG. 7, the rotor 78 is rotatably connected to a first shaft end 79 of a pinion shaft 81. The pinion shaft extends from its first shaft end 79 through the interior of the rotor 78 and beyond the rotor 78 and the stator 77 to its second shaft end 82 and is suitably supported with respect to the fork housing 71 and rotatably mounted in an intermediate portion therebetween via a bearing device 83, such as two tapered roller bearings spaced from each other, for example, or the like.

It should be understood that each of the third torque motors 74a, 74b has the same arrangement of the stator 77, the rotor 78 and the pinion shaft 81. Both pinion shafts 81 have an external toothing 84 at their second shaft end 82 and are in meshing engagement with a matching spur toothing 86 of a common driven gear 87. The pinion shaft 81 and the driven gear 87 form the one-stage reduction spur gear transmission 76 which preferably forms a non-self-locking, one-stage transmission and is mechanically or electronically clamped.

The driven gear 87 is rotatably coupled to the spindle device 18. The spindle device 18 comprises a spindle receptacle 88 with a housing 89 which is pivotally received about the third rotary axis C between the fork arms 68, 69. At the end of the spindle receptacle 88, which projects beyond the fork arms 68, 69, the milling spindle 11 protrudes from the housing 89 with its milling tool 91 which is used for machining a workpiece surface.

With further reference to FIG. 7, it can be seen that the housing 89 of the spindle receptacle 88 can be screwed to the driven gear 87, for example. An axial-radial bearing assembly 92 can axially and radially support the spindle receptacle 88 together with the driven gear 87 with respect to the fork housing 71 and support it for rotation. On the opposite (clamping) side another bearing is provided, which is not designated in detail. Different manners for supporting the spindle receptacle 88 are possible.

A third measuring system 93 may be provided to measure the angular position and/or angular velocity of the spindle device 18 about the third rotary axis A during operation. For this purpose, a driving shaft 94 may be attached to the spindle receptacle 88, wherein the driving shaft 94 projects from the spindle receptacle 88 into the interior space 73 of the fork arm 69 and may carry at its free end a material measure which can be detected by a sensor or a measuring transducer which is suitable attached to the fork housing 89. The angle measurement signals acquired by the sensor are transferred to the controller and used for positioning the spindle device 18 about the A-axis. As for the rotary axis C, hollow ring measurement systems or the like can also be used for the A-axis.

An axis clamping assembly 96 for the A-axis can be provided to lock or fix the spindle device 18 in a desired angular position about the A-axis when machining a workpiece surface to prevent a rotation of the spindle device 18 about the A-axis due to reaction forces during machining. If preferably two clamps are used on both sides of the spindle device 18, a higher stiffness in the A-axis can be achieved in the clamped state.

The milling head 9 comprises further devices and means, e.g. supply lines for feeding cooling air or a cooling liquid for the torque motors, for feeding a lubricant and/or for supplying a cooling medium which cools the milling tool 91 when machining a workpiece surface. Such devices and means are omitted in the figures for the sake of clarity and are as such not essential for the invention. However, it should be noted, that, due to the compact and open, easily accessible design of the milling head 9, which is in particular the result of the configuration of the drive devices 19, 21 and 22, a better accommodation of such means in a very restricted space within the support arm 14, the first head part 16 and, e.g. the interior space 72 of the fork 67 is made possible.

The milling machine 1 with the milling head 9 according to the invention described so far is arranged for simultaneous 6-axis machining of workpiece surfaces with high surface quality and is especially suitable for large-scale machining in the automotive and aerospace industries. It operates as follows:

In operation, a workpiece to be machined is positioned in the measuring space 13 on the measuring table 12. A numerical control of the milling machine 1 suitably controls the drives of the linear axes X, Y, and Z to move the milling head 9 into the position respectively suitable for milling. The entire machine structure with the sturdy side stands 2, 3, the structurally rigid portal 4, the linear drives, etc. is designed for high dynamic stiffness. It is thus possible to achieve very fast feed motions, high axes accelerations of even more than 5 m/s² and fast load changes without causing significant vibrations or oscillations.

Simultaneously with the control of the aforementioned linear drives, the controller activates the torque motors 27, 47a, 47b and/or 74a, 74b to effect rotation of the first head part 16 about the first rotary axis C relative to the support arm 14, rotation of the second head part 17 about the second rotary axis B relative to the first head part 16 and/or rotation of the spindle device 18 about the third rotary axis A relative to the second head part 17 and to thereby achieve a precisely controlled positioning of the milling spindle 11.

The oblique axis B, which is inclined to the C-axis, in combination with the construction of the first and second head parts 16, 17, enables relatively large pivoting ranges in the A- and B-axes. The inclination angle between the B- and the C-axis is preferably 30° to 60°, more preferably 40° to 50°. In particular embodiments, it is 45° or 50°. With an inclination angle of 45° between the B- and the C-axis, the (interpolated, “orthogonal”) spatial B-axis can be pivoted up to +/−45° or even more. In the illustrated example, the pivoting range in the A-axis is about −90° to +120° and may be even more depending on the design. With these pivoting ranges, very complex surfaces and details can be milled with very high qualities.

In the milling head of the invention the orthogonal B-axis of conventional three-axis milling heads of the cardan-type, for example, is replaced by the inclined axis B. An “orthogonal B-axis” (spatial B-axis) can in turn be interpolated or implemented by the superimposed motion of two or three of the axes A, B, C. Conversely, it is possible to use the coordinate system formed by the two axes A, C and the inclined axis B as the basis system for the machining operations and to calculate all required positionings of the rotary axes based on this system.

By using the three rotary or pivot axes A, B, C, which can all be driven independently of each other and simultaneously, the milling tool 91 can be transferred directly to the next required machining position. The machining speed can be increased significantly and the entire machining time can be reduced. A pole problem as in the classic milling head with rotary axes A and C does not exist. In addition, it is possible to perform an electronic orientation error compensation during the machining process. By means of the three rotary axes A, B, and C, deviations between the actual position and the desired position, which have been measured in advance, can always be corrected during a milling operation. As a result, requirements for accuracy in manufacturing and assembling components of the milling machine 1 in general and the milling head 9 in particular can be reduced while maintaining a high machining precision. Costs can be significantly reduced.

The milling head 9 according to the invention is well-suited, e.g. for hobbing pockets or circumferential contours with sloping walls. Such pockets or the like can be milled with the vertical or horizontal milling machine 1 according to the invention without interruption, without rotating the C-axis by 90° at each corner, as with two-axis milling heads, and without rewinding when the C-axis reaches its final position. This can be achieved only by appropriate control of the rotary axes A and B. In doing so, the C-axis can remain fixed or locked in a position during the entire milling process. However, the C-axis can also be used for the milling process if desired.

As a result of the inclination of the B-axis and the specific constructive design of the head parts 16, 17, housing parts of conventional three-axis assemblies, which are box-shaped and nested in one another, can be avoided. A compact milling head 9 with small interfering contour can be provided, which enables the milling of very fine contours in a small space. Selective measures, such as a backlash-free clamping of the gear devices 48, 76, the provision of torque motors 27, 47a, 47b and 74a, 74b for the rotary axes, constructive design of the elements, guides and bearings, which are precise and free of play, low construction volume and weight of the milling head, etc., provide the basis for a high dynamic stiffness and machining accuracy with high reliability, efficiency and durability of the milling machine 1.

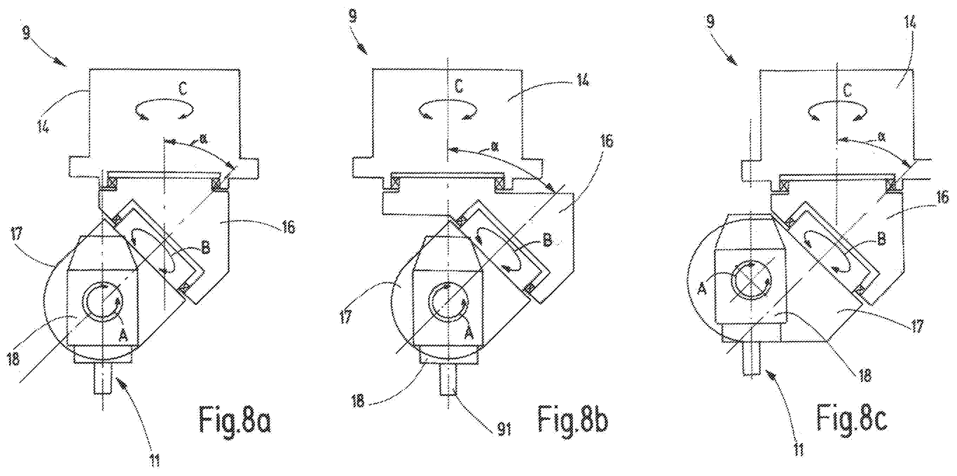

The milling head 9 according to the invention offers a high flexibility in the specific construction, which may vary depending on the application and environmental conditions. FIGS. 8a to 8c show different constructional variants of a tool head unit according to the invention, in greatly simplified schematic diagrams.

FIG. 8a shows a tool head unit which corresponds to the milling head 9 described above. The first rotary axis C defined by the support arm 14 and the third rotary axis A defined by the second head part 17 for the spindle device 18 are oriented orthogonally to each other, while the second rotary axis B for the relative rotation between the first and the second head part 16, 17 is oriented obliquely with respect to the C-axis and orthogonally with respect to the rotary axis A. In addition, the first and third axes C, A, are horizontally offset from each other, while the second axis B intersects these axes C, A. As a result of the axial offset or the eccentricity between the A- and C-axis, small lever arms and thus favorable power flows can be obtained, in particular on the first head part 16, which benefits the stiffness and dynamics. In addition, the interfering contour of the milling head 9 can be optimized.

FIG. 8b shows another variant in which all three axes A, B, and C intersect each other at a common point. The spindle axis of the spindle device 18 also passes through this point when the A- and B-axes are in the zero positions (A=0°, B=0°) shown in FIG. 8b. The arrangement of the axes A, B, C then corresponds to that of classic three-axes milling heads with a cardan structure, for example.

FIG. 8c shows a further variant in which the rotary axis A is offset from both the rotary axis C and the B-axis. As can be seen, this can reduce the length of the tool head unit 9 over the other variants, which may be advantageous for many applications.

In all variants shown in the FIGS. 8a-c, the first and the second rotary axes C, B (in their zero positions) and the spindle axis all run in a common plane. In principle, it is also possible to provide an axial offset along the A-axis, if desired or required. The milling head 9 offers many degrees of freedom in the choice of a suitable construction.

Further numerous modifications and variations of the embodiments described above and variations of the embodiments described above are possible within the scope of the invention. For example, in horizontal machine tools, the milling head 9 can also be movable along a horizontal Z-direction. Further, the shape of the head parts 16, 17 may differ from the illustrated shapes. In particular, the fork 67 may include only a single fork arm 68 or 69 on which the spindle device 18 is rotatably mounted. However, the described fork 67 with two fork arms 68, 69 provides better support and mounting of the spindle device 18, a higher rigidity and machining accuracy. The second head part 17 does not need to be fork-shaped.

Different configurations are possible for the drive devices 19, 21, and 22. In particular, for all rotary axes A, B, and C, preferably backlash-free drive types are usable, such as clamped drives with multiple motors or motor-gear combinations, wherein the gear units can be implemented in one or more stages, single-motor clamping drives, mechanically clamped gears, e.g. with clamping or Beveloid gears, worm gears or the like.

In addition, any mechanically, optically, magnetically or capacitively operating measurement systems, which are now known or developed in future, may be used as the measuring systems 37, 63 and 93. The required angular positions can also be derived indirectly from the relative angular position of the motor shafts or the like, for example.

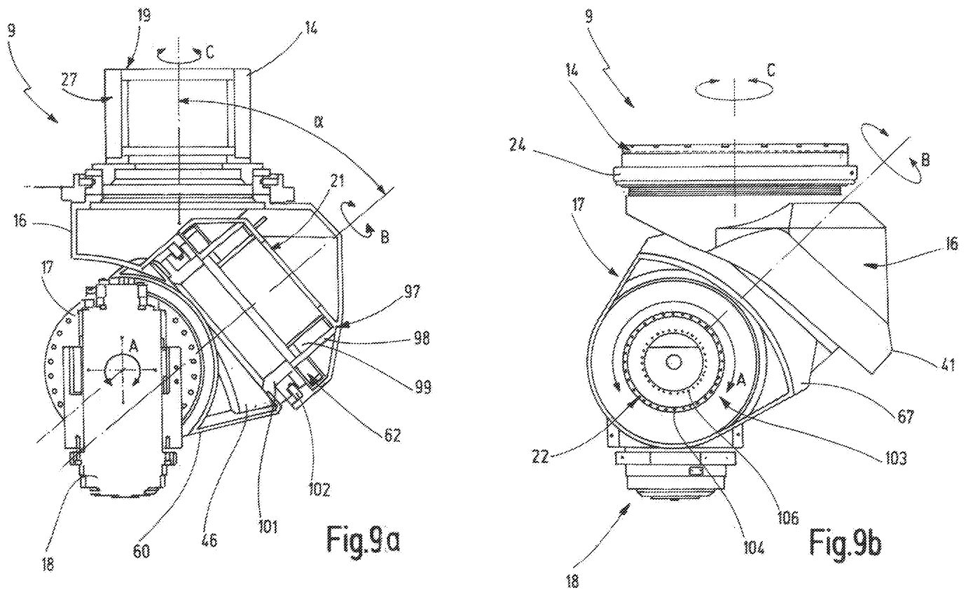

Further embodiments of present invention are shown in FIGS. 9a and 9b in very simplified illustrations. Insofar as there is conformity in construction and/or function, reference is made to the above description using the same reference numbers. The embodiment shown in FIG. 9a differs from that according to FIGS. 2-7 in particular in that a torque motor direct drive is provided here for the second drive device 21 associated with the second rotary axis B. It includes a torque motor 97 which is designed, as an example here only, as an external rotor with an internal stator ring 99 fixed stationarily to the angled housing 41 and an external rotor ring 98 concentric thereto and comprising permanent magnets, wherein the external rotor ring 98 is rotatably connected to a hollow cylindrical motor shaft 101. The motor shaft 101 is axially and radially supported and rotatably mounted in the angled housing 41 via suitable bearing means 102. At the end of the motor shaft 101 remote from the torque motor 97, the base 46 of the fork 67 of the second head part 17 is fixed to be rotated by the torque motor 97 about the B-axis.

As can be seen, the third rotary axis A is offset relative to the first C and the second rotary axis B in order to obtain as compact a construction as possible in the longitudinal direction of the tool head unit 9. An axis clamping unit 62 and an angle measuring system 63 for the B-axis are also provided.

The embodiment shown in FIG. 9b differs from the embodiments mentioned above in particular in that a torque motor direct drive is provided here for the third drive device 22 associated with the third rotary axis A. It comprises a torque motor 103 including an external stator ring 104 and a rotor ring 106 concentric therewith. The stator ring 104 and the rotor ring 106 are arranged concentrically to the A-axis, wherein the rotor ring 106 is rotatably connected to the spindle device 18 through a hollow output shaft, for example. Consequently, the spindle device 18 is directly rotatably driven by the torque motor 103 when machining a workpiece. Bearing means for supporting the rotor ring 106, one or more clamping units disposed on both sides for locking the A-axis during the machining of a workpiece and an angular measurement system for the A-axis are also present in the embodiment of FIG. 9b, although they are not shown for the sake of clarity.

As illustrated, the inclined axis B intersects here the A-axis to reduce lever arms for the power flow with respect to the A-axis, wherein an axial offset between the A- and B-axis may be provided depending on the application and need.

Incidentally, the embodiments according to the FIGS. 9a and 9b may be combined with each other to provide a tool head unit 9 in which all the rotary axes A, B, and C are driven by direct torque motors. This allows highest torques with extremely high rigidity and dynamics of the machine. In order to further increase the performance of the interchangeable head unit 9 and to reduce the radial dimensions of the components 14, 16, and 17, a tandem arrangement of two or more torque motors, which drive a common motor shaft together or in parallel, might also be provided for any of the axes A, B, C.

A three-axis tool head unit 1 for a machine tool spindle 11, in particular a three-axis milling head unit, is disclosed, which comprises three components 16, 17, 18, which are rotatable or pivotable relative to each other about independent axes A, B, C. A first head part 16 is rotatably mounted on a support arm 14 about a first axis C with respect to the support arm 14. A second head part 17 is rotatably mounted on the first head part 16 about a second axis B with respect to the first head part 16. A spindle device 18 is rotatably mounted on the second head part 17 about a third axis A with respect to the second head part 17. The third rotary axis A is oriented orthogonally to the first and the second rotary axes C, B, while the first and the second rotary axes C, B are inclined at an angle between 30° and 60° relative to each other. Each of the three rotary axes C, B, A has an individual drive device 19, 21, 22 associated therewith for driving and for controlling the rotation of the component 16, 17, 18 about its respective axis C, B, A. The three-axis tool head unit 1 offers large pivoting ranges of the axes with small interfering contour and allows fast and precise positioning of a machine tool spindle 11 into the required machining position. A machine tool 1, in particular a milling machine, with such a three-axis tool head unit 1 is also disclosed.

What is claimed is:

1. Tool head unit for machining workpieces, in particular a milling head unit for a milling machine spindle, comprising
a support arm (14), which defines a first rotary axis (C);
a first head part (16) mounted on the support arm (14), rotatably disposed about the first rotary axis (C) with respect to the support arm (14) and defining a second rotary axis (B) inclined with respect to the first rotary axis (C);
a second head part (17) mounted on the first head part (16) and rotatably arranged about the second rotary axis (B) with respect to the first head part (16);
a spindle device (18) mounted on the second head part (17) and rotatably arranged about a third rotary axis (A) with respect to the second head part (17); and
a first drive device (19), a second drive device (21) and a third drive device (22) respectively assigned with the first rotary axis (C), the second rotary axis (B) and the third rotary axis (A) for separately driving and controlling the rotations of the first head part (16), the second head part (17) and the spindle device (18) about the respective first rotary axis (C), the second rotary axis (B) and the third rotary axis (A).

2. Tool head unit according to claim 1, wherein the first rotary axis (C) and the third rotary axis (A) are oriented orthogonally with respect to each other and the second rotary axis (B) is oriented orthogonally with respect to the third rotary axis (A).

3. Tool head unit according to claim 2, wherein the first, second and third rotary axes (C, B, A) intersect in a common point.

4. Tool head unit according to claim 2, wherein the first and the third rotary axes (C, A) are offset from each other and the second rotary axis (B) intersects the first and third rotary axes (C, A).

5. Tool head unit according to claim 2, wherein the third rotary axis (A) is offset from the first and second rotary axes (C, B) and the second rotary axis (B) intersects the first rotary axis (C).

6. Tool head unit according to claim 3, wherein the first, second and third rotary axes (C, B, A) run in a common plane in the zero positions of all of the rotary axes.

7. Tool head unit according to claim 1, wherein the angle of inclination (a) of the second rotary axis (B) with respect to the first rotary axis (C) is in the range of 30° to 60°.

8. Tool head unit according to claim 1, wherein the support arm (14) comprises means (24, 26) for attachment to a machine tool (1), the first drive device (19) and a hollow cylindrical motor shaft (27) driveable thereby, which is arranged coaxially with the first rotary axis (C) and is configured for attachment of the first head part (16) thereto.

9. Tool head unit according to claim 8, wherein the first drive device (19) comprises a first torque motor (27) coupled thereto for direct rotatable drive of the motor shaft (27).

10. Tool head unit according to claim 1, wherein the first head part (16) comprises a cranked angled housing (41) with a first end which is formed substantially cylindrically and is configured to be mounted on the support arm (14) in a coaxial arrangement with the first rotary axis (C) and a second end (43) which defines a receiving opening (44) for the second head part (17), which is cylindrical and coaxial with the second rotary axis (B).

11. Tool head unit according to claim 10, wherein the second drive device (21) comprises at least a second torque motor (47a, 47b; 97) and a reduction gear transmission device (48) drivingly interposed between the second torque motor (47a, 47b) and the second head part (17).

12. Tool head unit according to claim 11, wherein the reduction gear transmission device (48) forms a non-self-locking, one-stage gear unit and is mechanically or electronically clamped.

13. Tool head unit according to claim 1, wherein the second head part (17) is formed as a substantially U-shaped fork (67) which comprises a base (46) for attaching the fork (67) to a driven part (59; 101) of the second drive device (21) and legs (68, 69) freely protruding from the base (46), running substantially parallel to and spaced from each other and forming fork arms (68, 69).

14. Tool head unit according to claim 13, wherein the spindle device (18) comprises a spindle receptacle (88) pivotally arranged between the fork arms (68, 69) and configured for receiving a spindle (11), which is rotatably driven by its own motor, and is securable or secured within the spindle receptacle (88).

15. Tool head unit according to claim 13, wherein each fork arm (68, 69) comprises a housing (71) which defines an interior space (72, 73) and the third drive device (22) is preferably completely accommodated within the interior space (73) of a single fork arm (69).

16. Tool head unit according to claim 11, wherein the third drive device (22) comprises at least a third torque motor (74a, 74b; 103) and a further reduction gear transmission (76) drivingly inserted between the third torque motor (74a, 74b) and the spindle device (18).

17. Tool head unit according to claim 16, wherein the further reduction gear transmission (76) forms a non-self-locking, one-stage gear unit and is mechanically or electronically clamped.

18. Tool head unit according to claim 16, wherein the second and/or the third drive device (21, 22) comprises/comprise a second and third torque motor (97, 103), respectively, which is arranged for direct rotatable drive of the second head part (17) and the spindle device (18), respectively.

19. Tool head unit according to claim 1, wherein each of the first, second and third rotary axes (C, B, A) has a measuring system (37, 63, 93) assigned thereto for measuring the relative angular position and/or angular velocity of a rotor with respect to a stator of the respective first, second and third drive device (19, 21, 22).

20. Machine tool, in particular a portal milling machine (1), having a support beam (8) which is positionable in a three-dimensional measuring space (13) and comprises a tool head unit, in particular a milling head unit (9), according to claim 1.
